(19) United States
(12) Patent Application Publication
(10) Pub. No.: US 2010/0283007 A1
(43) Pub. Date: Nov. 11, 2010

(54) Flexible luminescent paints

(76) Inventor: John Russell Robinson, Arundel (AU)

Correspondence Address: William R. Hyde, 1833 10th Street, Penrose, CO, 81240, US

(21) Appl. No.: 12/387,831

(22) Filed: May 8, 2009

(51) Int. Cl. C09K 11/64

(52) U.S. Cl. 252/301.36

(57) ABSTRACT

Flexible luminescent paints are prepared from physical blends of hybrid epoxy acrylic resins, cementicious acrylic resins and optionally pure acrylic coating resins together with monopropylene glycol, suspension additives, rheological additives and photoluminescent pigments. The luminescent paints exhibit bright, even and long-lasting photoluminescent afterglow, excellent flexibility in both thin and thick layers, and are suitable for spraying, brushing, rolling and screen printing. Optional fluorescent pigments may be utilized to give daylight coloration and up-convert the photoluminescent emissions to the fluorescent emissions color.

### BACKGROUND OF THE INVENTION

1. Field of the Invention

The present invention relates to luminescent paints. More particularly, the invention relates to flexible luminescent epoxy acrylic paints.

2. Description of Related Art

Examples of luminescence or “cold light” include the dim glow of phosphorus (a chemiluminescence), the phosphorescence of certain solids (phosphors) after exposure to sunlight, X-rays or electron beams, the transitory fluorescence of many substances when excited by exposure to various kinds of radiation and the electroluminescence of gases when carrying a current. There remains a need for a useful, renewable cold light source, particularly for photoluminescent paints which have the flexibility necessary for widespread applicability to new or existing articles and which will absorb light and then emit useful amounts of light over long periods.

Phosphorescent pigments are those in which excitation by a particular wavelength of visible or ultraviolet radiation results in the emission of light lasting beyond the excitation. After cessation of luminescence and renewed exposure to light, the material again absorbs light energy and exhibits the glow-in-the-dark property (an absorbing-accumulating-emitting cycle). Many phosphorescent pigments suffer from the problems of low luminescence and/or short afterglow.

Various phosphorescent substances are known, including sulfides, metal aluminate oxides, silicates and various rare earth compounds and oxides. The most common type of phosphorescent pigment is a zinc sulfide structure with substitution of the zinc and activation by various elemental activators. Other sulfide phosphors which emit various colors of light include ZnCdS:Cu and ZnCdS:Ag, CaS:Bi, CaSrS:Bi, alpha barium-zinc sulfides, barium-zinc-cadmium sulfides, strontium sulfides, etc. The most important class of long-life phosphorescent pigments is the metal aluminates, particularly the alkaline earth aluminate oxides. Examples are strontium aluminum oxide (SrAl₂O₄), calcium aluminum oxide (CaAl₂O₄), barium aluminum oxide (BaAl₂O₄). and mixtures. These aluminate phosphors may be further activated with other metals and rare earths. The initial afterglow brightness and afterglow period is up to ten times that of conventional zinc sulfide based phosphors. Afterglow brightness increases with increase in light source intensity; afterglow brightness is also proportional to the intensity of UV contained in the excitation light. Coarser particles will have better brightness and afterglow.

Alkaline earth metal aluminate oxide phosphors and their preparation are discussed, for example, in U.S. Pat. No. 5,424,006 (1995) to Murayama et al. for Phosphorescent Phosphor. Alkaline earth aluminum oxide phosphors of formula MAl₂O₄ were prepared where M was selected from calcium, strontium, barium or mixtures thereof, with or without added magnesium. The phosphorescent aluminates were activated with europium and co-activated with lanthanum, cerium, praseodymium, neodymium, samarium, gadolinium, dysprosium, holmium, erbium, thulium, ytterbium, lutetium, tin, bismuth or mixtures thereof. The alkaline earth metal type aluminate phosphors of Murayama et al. were developed in response to the problems with zinc sulfide phosphors decomposing as the result of irradiation by ultraviolet (UV) radiation in the presence of moisture (thus making it difficult to use zinc sulfide phosphors outdoors and exposed to direct sunlight) and problems of insufficient length of afterglow. The metal aluminate phosphors such as activated alkaline earth aluminate oxides exhibit UV insensitivity and bright and long-lasting afterglow luminance. However, metal aluminate phosphors may be at a disadvantage compared to zinc sulfide phosphors in requiring a considerably long time and/or more intense illumination for excitation to attain saturation of afterglow luminance as well as sharing a vulnerability to water and moisture. This points out the need for adaptation of specific phosphors and mixtures of phosphors for use in varying excitation conditions, a need for water-resistant formulations suitable for protecting phosphorescent particles and a need for UV protection where sulfides are utilized.

Phosphorescent materials have found use in a variety of commercial applications including signs, machinery marking, dial illumination, marking the edge of steps, fire helmets, accident prevention, protective clothing, sports equipment, etc. Commercially available sheets of phosphorescent material are typically phosphorescent pigment in clear polyvinylchloride. Other approaches are also utilized, usually involving thermoplastics (which may be repeatedly softened by heating and hardened by cooling) or elastomeric and rubbery materials.

U.S. Pat. No. 6,207,077 (2001) and U.S. Pat. No. 6,599,444 (2003) for Luminescent Gel Coats and Moldable Resins, U.S. Pat. No. 6,818,153 (2004) for Photocurable Thermosetting Luminescent Resins and U.S. Pat. No. 6,905,634 (2005) for Heat Curable Thermosetting Luminescent Resins, all to Burnell-Jones, disclose various polyester luminescent resins including flexible polyester resins. However, the flexible resins are of limited flexibility and become less flexible and more brittle very soon after application, especially in thick coatings. They also have no elasticity, even in flexible format and are not suitable for very flexible substrates, e.g. cloth. In addition, they are subject to yellowing in sunlight during continuous exposure. They are also high VOC and solvent based with all the inherent disadvantages for storage, handling and transport.

U.S. Pat. No. 4,211,813 (1980) to Gravisse et al. discloses photoluminescent textile and other flexible sheet materials coated with a thin film of photoluminescent synthetic resin. A textile material was coated with a synthetic resin containing a phosphorescent metal sulphide and a substance which absorbs energy of short wave-length and emits energy at wave-lengths which lie within the absorption spectrum of the phosphorescent constituent. Preferred resins were polyurethane resins, polyvinyl chloride resins, polyacrylates and/or acrylates, elastomeric silicones and combinations of these resins. The preferred phosphorescent sulphide was zinc sulphide, with calcium, cadmium and strontium sulphides also being utilized. While suitable for garments, this approach relies on the flexibility of the base fabric and a thin 40-200 μm coating to impart the flexibility in the finished product. While the 40-200 μm coating in itself is flexible to a degree, unsupported or on its own it would not have the flexibility or elasticity to allow thicker coating and/or coating by spray or brush in coating thicknesses of 1,000 μm or greater.

Polymer epoxies were utilized in U.S. Pat. No.5,395,673 (1995) to Hunt, which discloses a composition useful for non-slip ground surfaces where lighting conditions may be poor. The composition preferably includes a polymer epoxy (diglycidyl ether resin aliphatic amine adduct modified with amyl ethyl piperidine as a stabilizer), a phosphorescent pigment (preferably copper activated zinc sulfide) and an aggregate such as aluminum oxide. However, epoxies possess limited flexibility and corresponding brittleness due to cured hardness, such that they typically cannot be applied even to medium hard surfaces such as wood.

Hybrid epoxy acrylic waterborne resins are known to the art with sufficient flexibility to be applied to surfaces such as wood, and are known for superior gloss, optical clarity and weathering resistance, but nevertheless provide only very limited flexibility due to cured harness. In common with other resins, there is a problem with suspending high loadings of the dense photoluminescent pigments.

It is also known that photoluminescent pigments can be added to a variety of solvent based and water borne paints. The problem that is common to these types of photoluminescent paints, including acrylic based and “latex” paints, is that they have low flexibility levels when utilizing photoluminescent pigments at addition rates of between 10 and 40 percent by weight. This severely limits the ability of these paints to be made photoluminescent by the addition of photoluminescent pigments and also severely limits the ability of these paints to be applied in coatings of sufficient thickness to produce high levels of photoluminescence. The reduction in flexibility due to addition of photoluminescent pigments is also compounded by the nature of the resins being utilized in these paints, as they do not possess sufficient flexibility to allow thicker coats as required in the photoluminescent art, thus resulting in hard and brittle coatings that will crack with minimal bending.

Another problem with utilizing phosphorescent pigments (which may have a specific gravity of 3.5 to 4 or more) in paints is the tendency of the phosphorescent pigment to settle and fall out of suspension during storage and shipping; this problem is particularly aggravated when using larger size luminescent particles. This causes the pigment to agglomerate and makes it very difficult to successfully re-mix into the paint base without causing resultant lumps of dried pigment and resin. Usually known luminescent paints and polymers must be blended and utilized immediately in order to successfully suspend the pigments, often with air equipment to keep the phosphorescent particles in suspension. Thus, there is a particular need for paint methods and products which keep the phosphorescent particles in suspension not only during blending and application, but also during storage over the useful life of the luminescent paint or polymer.

In summary, there remain various needs and unsolved problems which must be overcome before paints can be most effectively utilized with the various phosphorescent particles. An effective paint must be low volatile organic content (“VOC”), water-resistant, protect UV sensitive phosphorescent pigments and provide a means for keeping heavy phosphorescent particles in suspension during storage and use. Such paints or polymers should have acceptable optical properties for use with phosphorescent pigments. An ideal paint would have excellent flexibility and photoluminescent properties.

### SUMMARY OF THE INVENTION

In view of the foregoing disadvantages inherent in the known types of luminescent materials, the present invention provides improved luminescent paints. The luminescent paints have improved flexibility and protective qualities, improved luminescent properties and improved phosphor-suspending properties for ease of storage and use.

The luminescent paints may be conveniently fabricated by mixing various epoxy acrylic hybrid resins and cementitious acrylic resins, optionally including also a pure acrylic resin, and various additives to produce a low VOC waterborne resin carrier suitable for use with phosphorescent pigments. Preferred phosphorescent pigments include activated metal aluminate oxide phosphors such as alkaline earth aluminate oxides; optional fluorescent pigments may also be utilized. The luminescent paints may be applied by various methods including spraying, rolling, brushing and screen printing. The luminescent paint coatings may be applied at thicknesses in excess of 1,000 grams per square meter (1,000 μm and greater thickness) and still retain high flexibility and elasticity.

The improved luminescent paints of the present invention show unexpected properties including a combination of bright and extremely long glow, up-conversion of photoluminescent glow through the use of optional fluorescent pigments, extreme flexibility and an ability to keep heavy phosphorescent particles in suspension during extended storage and use.

Accordingly, it is an object of the present invention to provide a luminescent paint with both a bright initial luminescence and a long-lasting luminescence.

It is another object of the present invention to provide a luminescent composition useful as a paint, coating and screen printing ink resin.

It is another object of the present invention to provide luminescent paints with excellent weather and water resistance.

It is another object of the invention to provide luminescent paints that may be applied in thick, flexible coats via spraying, rolling, brushing and/or screen printing.

It is another object of the invention to provide luminescent paints with daylight colors and up-conversion of photoluminescent pigment spectra via fluorescent pigments.

It is another object of the present invention to provide luminescent paints suitable for long term storage and use.

A further object of the invention is to provide a method for efficient production of photoluminescent paint materials demonstrating excellent light density, light fastness and afterglow combined with excellent paint properties and suspension of phosphorescent pigments.

The luminescent paints disclosed herein have been found to achieve these objects and advantages. Other objects and advantages of this invention will become apparent from the following description and appended claims.

### DETAILED DESCRIPTION OF THE INVENTION

Before explaining the preferred embodiments of the present invention in detail, it is to be understood that the invention is not limited in its application to the particular details disclosed. No limitation with respect to the specific embodiments disclosed is intended or should be inferred. Although the present invention has been described with reference to preferred embodiments, numerous modifications and variations will be apparent to one skilled in the art. These modifications can be made and still the result will come within the scope of the invention. The terminology used herein is for the purpose of description and not of limitation.

In attempting to address the known problems present in the prior art, the present inventor has discovered that a novel physical mixture of epoxy acrylic hybrid waterborne emulsion resin and a cementitious acrylic emulsion resin and additives including a glycol (dihydric alcohol), Theological or thixotropic additives and suspending filler unexpectedly provides the resin basis for a superior flexible photoluminescent paint, including low volatile organic contents (VOC) and resultant environmental advantages.

The superior properties of the resultant flexible luminescent paints are particularly unexpected as physical blends of epoxy and acrylic resins often encounter poor compatibility problems, generally exhibit poor film and the epoxy resin in the physical blend normally does not coalesce the acrylic resin efficiently. See Pub. No. EP0770635 (1999) to Liu et al. for Reactive Solvent Containing Epoxy and Epoxy-Polyacrylate Dispersions, Process for Their Preparation and Their Use. It would therefore not be obvious to physically combine hybrid epoxy acrylic and acrylic resins, and it would be particularly non-obvious to combine a hybrid epoxy acrylic resin with a cementitious acrylic resin. Nor would it be obvious to combine these resins with a glycol, as each of these components typically find use in totally disparate and dissimilar classes of products.

Examples of hybrid epoxy acrylic waterborne emulsions include those discussed in the examples below and those disclosed in, for example, U.S. Pat. No. 4,028,294 to Brown et al. for Epoxy Modified Acrylic Latices and Method of Producing Same, U.S. Pat. No. 5,942,563 to DeGraaf for Aqueous Dispersed Acrylic-Epoxy, Branched Epoxy Protective Coatings, U.S. Pat. No. 5,922,817 to Pederson et al. for Water-Dispersible Polymer and Coating Composition Containing the Same, U.S. Pat. No. 6,008,273 to Leibelt et al. for Waterborne Coating Compositions for Metal Containers, U.S. Pat. No. 6,306,934 to Bode et al. for Aqueous Coating Composition and Pub. No. EP0770635 (1999) to Liu et al. for Reactive Solvent Containing Epoxy and Epoxy-Polyacrylate Dispersions, Process for Their Preparation and Their Use. Also known to the art are varying epoxides, polyepoxides, and core-shell epoxies hybridized with acrylic lattices. Such resins on their own are not suitable due the cured hardness and resultant lack of flexibility as well as problems resultant from photoluminescent pigment loading.

Numerous examples of acrylic emulsion resins, including 100% acrylic resins, are widely known to the art for use in blending with cement. Such cementitious (also known as cementaceous or cementicious) acrylic resins add shock resistance and flexibility to cured concrete while displaying no degradation or color development on exterior exposure. Such resins are designed to be additions to concrete, not as stand alone formulations or paints, and are not suitable on their own as a carrier for phosphorescent pigments. Although designed to improve the properties of concrete, they have unexpectedly been found to be uniquely suited to impart elasticity and flexibility to hybrid epoxy acrylic resins and allow high photoluminescent pigment loadings while solving brittleness and phosphorescent pigment loading problems.

Cementitious acrylic resin formulations designed to be blended with cementaceous substrates (such as RayCryl® 401 and Rohm and Haas Primal (Rhoplex) MC1834 below) do not require a coalescing solvent or coalescent, and when added to the formulation, they impart excellent flexibility and elasticity to the coating.

The flexible luminescent paint may optionally include non-cementitious, waterborne pure acrylic emulsions used for exterior and interior decorative coatings. Unlike the hybrid epoxy acrylic resins and the cementitious resins, the pure acrylic emulsions require a coalescent to form film. The optional pure acrylic resins designed for coating and sealing substrates (such as Alberdingk® AC2514, Alberdingk® AC2523, RayFlex® 610, RayCryl® 708E and Rohm and Haas Primal (Rhoplex) AC630 below) require a coalescent; when combined with the hybrid epoxy acrylic and cementicious blending resins they impart improved UV stability, optical clarity and toughness to the finished coating.

It was also desirable to develop a luminescent paint in a form that would allow application by HVLP spray, by paint brush and roller and/or by screen printing, all without having to change the formulation. Along with this was the need to allow the pigment to be suspended in the paint for extended storage periods without settling, and to withstand the shaking experienced during road or rail transport or being subjected to high temperatures in shipping containers for many weeks.

Consideration of the rheology or thixotropy was to maintain a rheology profile that would produce a paint that was not too thick to allow spray application, was brushable allowing good film build, and would deposit onto the surface when rolled. Rheology additives known to the art were selected; illustrative examples from Rohm and Haas are included below. The rheological and thixotropic characteristics of paints need to be precisely controlled in view of the thickness of the deposited film and the tendency of such films to sag. The paint should be uniformly thixotropic so as to eliminate dripping when applied to vertical surfaces and void-free dense surfaces.

Monopropylene glycol is used to replace some of the water and to slow down the evaporation rate and cure rate so that the paint does not dry too quickly. Glycols such as monopropylene glycol are known to the art as a component of polyester resins and are used extensively in the paint industry as a compatibilizer and for freeze/thaw protection in waterborne paints. Other suitable glycols known to the art, such as, for example, dipropylene glycol, or other suitable compatiblizers may be utilized.

The suspension additive or agent to assist in the suspension of dense photoluminescent pigments was selected from a variety of possible suspension agents, fillers and/or bentonite clays. Major considerations are to have a suspension agent that will not thicken the paint beyond what the rheology additives had thickened the paint, and to be as transparent as possible so as not to hinder the ability of the photoluminescent pigment to absorb light energy and emit that stored energy as visible light during darkness. The additive of choice was Laponite RDS synthetic layered silicates, which dissolve in water to form a thin gel. It was tested under shaking and extreme temperatures in the paint and kept the pigment fully suspended when used in conjunction with the rheology additives. Other known suspension agents or additives with appropriate optical properties may also find use.

For flexible luminescent paints without the optional pure acrylic additive, the preferred ratio of resins would be 30-70% hybrid epoxy acrylic to 10-40% cementitious acrylic with a balance of water and additives. More preferred is 40-70% epoxy acrylic to 15-35% cementitious acrylic and the balance as water and additives. Most preferred would be 50-70% epoxy acrylic to 15-30% cementicious acrylic with the balance as water and additives. If an optional pure acrylic resin is utilized, the preferred ratio of resins would be 20-50% hybrid epoxy acrylic to 5-40% cementitious acrylic to 10-45% pure acrylic with the balance as water and additives. More preferred would be 20-45% epoxy acrylic to 10-40% cementitious acrylic to 15-45% pure acrylic with a balance of water and additives. Most preferred would be 20-40% epoxy acrylic, 10-35% cementitious acrylic and 25-45% pure acrylic with the balance as water and additives.

In general, long-life, weatherproof and lightfast photoluminescent and fluorescent pigments are preferred, including those pigments with weatherproof or weather resistant resin coatings and UV protectants. Various considerations are taken into account when choosing a phosphor or mixture of phosphors for use in various applications. Activated alkaline earth metal aluminate oxides are in general preferred due to their brighter initial afterglow and longer afterglow.

The preferred photoluminescent particle size will be dependent on the smoothness of the finish of the cured paint required. If a thick coating (1 mm to 1.5 mm) is desired and smoothness is not an issue, then a larger size particle is used, for example 65-85 μm particles. If a thinner coating is desired, for example, either a 35-65 μm particle size or a combination of 15-35 μm and 35-65 μm particles would be used. If it is to be applied by screen printing, then the finer 15-35 μm particle size is used. It is preferable that the photoluminescent pigment and any optional fluorescent pigment be waterproof or treated to give waterproof properties, as non-treated pigments easily oxidize with subsequent reduction in glow properties of the pigments.

The coating thickness per single coat will depend on application method. Brush or roller application of the coating will offer much thinner coats than spraying, which is the preferred method as it offers much more uniform application. The thinnest coat (cured coating) depends on the pigment particle size, and percentage of pigment to resin formulation, utilized in the formulation. Finer particle size pigments (15-35 um) allow for more filling of the matrix due to larger surface area of pigment per unit of addition, thus resulting in a more complete glow in the finished coating. Coating applied in this way will be suitable with cured coating thickness of 0.5 mm to 1.0 mm.

If larger particle size pigment is used in the formulation, then, due to the smaller surface area per unit of pigment in the formulation, the coating will need to be thicker to prevent “speckling effect” in the glow. In thinner coatings, this is caused by insufficient surface area of the pigment particles to fully fill the matrix of the coating, so a much thicker coating is required, and this should be in the range of 0.75 mm to 1.5 mm in order to produce an even glow effect. It is recommended that the luminescent paint coating has a cured thickness of no less than 0.75 mm for coatings containing small particle size pigment (15-35 μm) and no less than 1 mm cured thickness for coatings containing particle sizes of greater than 35 μm.

Colored lightfast fluorescent pigments such as the DayGlo® Lightfast Saturn Yellows® (below) can be utilized to up-convert the light from the photoluminescent pigment (changing the luminescent paint “glow” color to that of the fluorescent pigment) or utilized to give the paint a different daylight color. Typically the photoluminescent and fluorescent pigments are utilized in a ratio of 60:1 to 150:1.

Optional ingredients known to the art to brighten and improve reflective qualities include luminescence enhancers such as optical brighteners, fluorescent whiteners, color brighteners and spectrum enhancers. Fluorescent daylight pigments benefit from UV protection.

Suitable sources of excitation for the photoluminescent polymers disclosed herein include daylight, UV light and most forms of artificial light. In general, the wider the spectrum of the energizing light, the longer the afterglow of the photoluminescent plastics. White light rich in UV is very suitable.

The following chemical compositions have been used in the illustrative examples below. They should be considered as examples of compositions that may be used to practice the present invention and not as unduly limiting. It will be apparent to those skilled in the art that many similar commercially available or readily synthesized materials may be utilized.

Alberdingk® M2954 (Alberdingk Boley, Inc.) is a tall oil resin-supported, self cross linked aqueous epoxy acrylic hybrid copolymer emulsion with a very high surface hardness. It is suitable for blending, coating metal, cement and plastics and provides a wet look. It has a high Tg (75° C.), 78° C. MFFT, 46.5% NVW and a pH of 8.7.

Alberdingk® M 2959 (Alberdingk Boley, Inc.) is an epoxy acrylic hybrid copolymer emulsion that provides water, alkali, efflorescence and corrosion resistance, good adhesion and exterior durability. It is suitable for wood, metal, concrete, primers and sealers. It has a viscosity of 150 cps, a 19° C. Tg, 20° C. MFFT, 47% NVW and a pH of 6.5.

Alberdingk® M 3000® (Alberdingk Boley, Inc.) is a self cross-linking epoxy acrylic hybrid copolymer emulsion for wood and concrete applications with excellent early block resistance, chemical resistance to cleaners, high scrubability and wet adhesion to alkyds. It is 48% solids, has a viscosity of 100 cps, a Tg of 23° C., a MFFT of 19° C. and a pH of 6.5.

Primal™ MC-1834 (Rohm and Haas Australia Pty. Ltd.) (=Rhoplex™ MC-1834P, Rohm and Haas) is a cementitious 100% acrylic low velocity emulsion with a nonionic charge for blending with cementaceous substrates and enhancing the durability, adhesion and flexural, tensile, compressive and impact strengths of cement-based products and stuccos and formulating conventional and lightweight renders and coatings, waterproofing systems, patching and repair mortars, underlayments and commercial flooring. It is 46% solids and 54% water with a dynamic viscosity of 10-60 mPa·s., a Tg (glass transition temperature) of 5° C. (DSC onset), a viscosity of 20 cps and a pH of 9.3 to 10.2.

RayCryl® 401 (Specialty Polymers, Inc.) is a low-odor cementitious 100% acrylic emulsion resin with a nonionic surface charge designed for blending with cement for flexible stamped concrete and crack resistant stucco patches and overlays with crush strength and crack resistance. It is 47-49% weight solids, has a Tg (MDSC) of 8° C., a MFFT (ASTM D-235) of 0° C., a viscosity (Brookfield model RVT, #3/100 rpm) of 300 cps, a mean particle size of 0.24 microns, a pH of 8.5-9.5 and a coating VOC (g/L) of <50.

RayCryl® 708E (Specialty Polymers, Inc.) is a low VOC pure acrylic emulsion resin with an anionic surfactant charge designed for low VOC coatings and sealers. It provides good block resistance and hardness with low coalescent demand. It has excellent UV durability which allows it to be formulated into exterior coatings for wood and cementaceous substrates including concrete and roof tile. It is 47-51% weight solids, has a Tg (MDSC) of 21° C., a MFFT (ASTM D-235) of 12° C., a viscosity (Brookfield model RVT, #3/100 rpm) of 40-500 cps, a mean particle size of 0.16 microns, a pH of 8-10 and a coating VOC (g/L) of <50.

Rhoplex™ AC-630 (Rohm and Hass) (=Rohm and Haas Acrysol™ AC630 Acrylic) is a clear and colorless pure acrylic aqueous emulsion resin used as an aqueous vehicle with low VOC requiring low defoamer levels in tough, water-resistant sealers over cementaceous substrates. These coatings are commonly factory-applied to retard efflorescence of cured cementaceous products formed in plants under controlled conditions. Typical applications include roofing tiles and other precast construction products. It also finds use in cement/concrete additives. It is 50% solids by weight, has a viscosity of 200-600 cP, a minimum film formation temperature (MFFT visual) of 17° C., a Tukon hardness (KHN) of 2-3 and a pH of 9-10.

RayFlex® 610 (Specialty Polymers, Inc.) is an pure acrylic polymer emulsion with an anionic surfactant charge. It is 55.5% to 59.5% solids by weight with a mean particle size of 0.27 microns, pH of 8 to 9, TG of 13° C. and MFFT of 0° C. It has excellent water resistance and good adhesion to most substrates. Rayflex 610 has excellent flexibility and elongation to aid in crack resistance during cold weather applications. It is often used in the formulation of rubber tire sidewall paint due to its high flexibility and elongation.

Alberdingk® AC 2514 (Alberdingk Boley, Inc.) is a pure acrylic medium hard self cross-linking aqueous acrylate copolymer preparation with hardness, gloss and chemical resistance suitable for wood, primer and sanding sealer. It is 42-44% acrylate copolymer and 0.5-1.0% surfactant, has a viscosity of 100 (30-300 mPa·s Brookfield RVT, spindle 1, 20 RPM @20° C. ), a MFFT of 45° C., Tg of 52° C., a Koenig Hardness (s) of 110 and a pH of 7.5.

Alberdingk® AC 2523® (Alberdingk Boley, Inc.) is a pure acrylic self cross-linking low VOC aqueous core shell fine dispense acrylic copolymer dispersion without plasticizers and protective colloids for zero VOC high gloss applications. It has good blocking resistance and low water absorption, ideal for high gloss enamels with wet adhesion and exterior durability. It is 48% acrylic copolymer and 0.5-1.0% surfactant, has a viscosity of 2500 cps, a Tg of 0° C., a MFFT of 0° C., a Koenig hardness (s) of 46 and a pH of 8.

MPG Industrial (Shell Chemicals) is a high purity grade (99.5% min.) of monopropylene glycol (1,2-propanediol or 1,2-dihydroxy propane). Monopropylene glycol is primarily used as a building block for unsaturated polyester resins and is used in the paint industry as a compatibilizer and for freeze/thaw protection. Monopropylene glycol functions in the present invention to slow the cure rate of the emulsion.

Acrysol™ ASE-60 (Rohm and Haas) is an anionic thickener and low shear viscosity builder for paints and coatings that also provides sag, spatter and microbe-enzyme resistance. It is 28% solids, has a Brookfield Viscosity (RVT, 12 rpm) of 10 mPa·s and a pH of 3.5.

Acrysol™ RM-2020NPR (Rohm and Haas Asia Pacific) is a non-ionic, solvent-free, bio-stable hydrophobically-modified ethylene oxide urethane (HEUR) rheology modifier that provides flow and leveling, film build and film formation, gloss development, improved syneresis resistance and high shear (film build) viscosity in interior and exterior latex paints. It is 20% solids by weight and can be used as a sole thickener when used in combination with small particle size hydrophobic binders for high gloss through semigloss acrylic paints. It is a low viscosity liquid (1400-1899 cps, Brookfield, #2, 60 rpm) that can be diluted with water for easy handling.

Acrysol™ SCT-275 (Rohm and Haas) is a nonionic, hydrophobically modified ethylene oxide urethane (HEUR) rheology modifier and viscosity builder which imparts rheological properties to latex based paints and coatings. It has a high resistance to water, corrosion, alkali, syneresis and microbial attack, is useful in a wide pH range for paint and coatings and imparts excellent finished paint appearance, spatter and sag resistance, flow and leveling properties, increased film build, uniform edge coverage and improves film appearance during and after application. It is 17.5% solids with a solvent ratio of 75% water and 25% diethylene glycol monobutyl ether. It has a low to medium shear rate and is a low viscosity liquid with a Brookfield viscosity (25° C.) of 2500 cps.

Texanol™ (Eastman) is 100% trimethyl hydroxypentyl isobutyrate (2,2,4-trimethyl-1,3-pentanediol monoisobutyrate) ester alcohol, a coalescent for latex paints over substrates with different levels of porosity. It imparts film integrity at low levels of coalescent, enhancing the performance properties of the paint including low temperature coalescence, touch-up, scrub resistance, washability, color development, thermal flexibility, and resistance to mudcracking. Texanol ester alcohol also enhances thickening efficiency when used with associative thickeners. It also find use as a retarder solvent for use in coil coatings and high-bake enamels, as a chemical intermediate for synthesis of ester derivatives for plasticizers, and applications in ink applications requiring good open, ore flotation/frothing, oil-drilling muds, wood preservative carriers, personal care products and floor polishes. It has a viscosity @20° C. of 13.5 cP (mPa·s).

Vantex® T (Taminco Higher Amines, Inc.) is a zero VOC low odor coalescent neutralization alkyl alkanolamine additive for use in high performance low/zero VOC waterborne coatings. Vantex® T enhances film formation, corrosion resistant properties and as part of a paint's coalescing system allows for the reduction or elimination of employed solvents while providing excellent film forming properties. It has a viscosity of 100 cP @15° C.

Tamol™ 850 scale inhibitor (Rohm and Haas) is a thermally stable synthetic polymer utilized in boiler feed water and recirculated cooling water to inhibit scale and corrosion and promote efficient heat transfer. It has excellent dispersant activity and is utilized in the present invention as a pigment dispersion agent. It is 29-31% sodium salt of PMAA (polycarboxylate with a molecular weight of 30,000), 69-71% water, ≦0.1% residual monomers and ≦500 ppm formaldehyde. It is has a Brookfield viscosity of 250 @25° C., 470 @5° C. (mPa·s/cps, spindle speed #2 @60). Tamol 850 exhibits very little surface activity and is essentially nonfoaming.

Zonyl FSJ (DuPont) is a relatively low foam blend of an anionic fluorosurfactant CF(CF₂CF₂)₁₋₇(CH2CH2O)₁₋₂PO(O⁻NH₄⁺)₁₋₂ and a hydrocarbon surfactant which reduces surface tension to improve flow and wetting and reduce surface defects (including cratering, pin holing and orange peel over contaminated surfaces) and functions as an antiblock additive. It is 40% fluorosurfactant, 15% isopropyl alcohol and 45% water and has a pH of 7-8.

DC65 defoamer (Dow Corning) is a water-based silicone emulsion antifoam for ink and coatings that also improves leveling, wetting, mar resistance and slip. It contains 3-7% octamethylcyclotetrasiloxane, 3-7% octylphenoxy polyethoxy ethanol, 3-7% polyether polyol, 1-5% treated silica, 7-13% hydroxyl-terminated dimethyl siloxane, 15-40% polydimethylsiloxane and 41% water. The viscosity at 25° C. is 2000 cps.

AMP-95 (Angus Chemical Co.) is a multifunctional additive (2-Amino-2-methyl-1-propanol with 5% added water) for latex paints providing dispersant, thickener, surfactant and defoamer properties to enhance film performance. It also contributes pH stability and anticorrosive properties and scavenges small amounts of formaldehyde in aqueous solutions that would otherwise be released to the air. It has a viscosity at 25° of 147 cps and a pH of 11.3.

Kathon™ LX 1.5% in-can microbicide (Rohm and Haas) is a broad-spectrum preservative effective against gram-negative and gram-positive bacteria and fungi including yeasts and molds for latex paints, coatings, polymer lattices and dispersed pigments. Active ingredients are 1.5% 5-chloro-2-methyl-4-isothiazolin-3-one and 0.35% 2-methyl-4-isothiazolin-3-one, inert ingredients are 3% magnesium nitrate, 0.15% copper and 95.35% water. The viscosity is 3 cps at 25° C. and the pH is 3.

Laponite® RDS (Southern Clay Products-Rockwood Specialties, Inc.) totally synthetic layered silicates for waterborne systems are platelets that can generate clear solutions in water, generate thixotropy (thixotropic rheology), control color migration and help generate pleasing texture and consistency. Particle size is 98% 250 M and maximum moisture is 10%.

Yixing HV-8BK (65-85 μm), HV-8CK (35-65 μm), and HV-8DK (15-35 μm) green glow pigments (Yixing Luminous Products, Inc., China) are waterproof alkaline earth metal aluminate (including SrCO₃, Eu₂O₃ and Al₂O₃) photoluminescent pigments that give excellent green glow properties. They have a pH in water of 7.2-7.8.

DayGlo® LFY17 Lightfast Saturn Yellow® pigment (Day-Glo Color Corp.) is a thermoplastic modified polyamide resin-coated fluorescent pigment produced in accordance with U.S. Pat. No. 6,103,006. The fluorescent dyes are incorporated into the backbone of the polymer chain and include both conventional fluorescent organic dyes and/or BXDA. LFY17 provides excellent lightfastness, heat stability, low mold plateout and large particle size to maximize loadings and reduce dusting. It has a specific gravity of 1.20 and a particle size of 20-60 microns. LFY17 is used in the present invention to produce coatings with a safety yellow daylight color and/or to up-convert the glow emission color of the photoluminescent pigment, changing the luminescent paint color from green glow to yellow glow. The Lightfast Saturn yellow is also preferred as a fluorescent pigment because it is lightfast as opposed to most fluorescent pigments which have very short lifespans under UV exposure conditions. If making an outdoor safety yellow then the photoluminescent pigment is, for example, approximately 30% of the total formulation, and LFY17 fluorescent pigment is approximately 0.2-0.5% of total formulation.

The components described above have been found to be useful in the following ranges:

| | Variable Addition | |
|---|---|---|
| | Range | |
| Component | From % | To % |
| Alberdingk M2959 Epoxy Acrylic Hybrid | 0 | 65 |
| Alberdingk M2954 Epoxy Acrylic Hybrid | 0 | 30 |
| Alberdingk M3000 Epoxy Acrylic Hybrid | 0 | 30 |
| Specialty Polymers RayCryl 401 Cementitious | 0 | 30 |
| Acrylic | | |
| Rohm and Haas Primal (Rhoplex) MC1834 | 0 | 30 |
| Cementitious Acrylic | | |
| Specialty Polymers RayCryl 708E Acrylic | 0 | 75 |
| Specialty Polymers RayFlex 610 Acrylic | 0 | 20 |
| Rohm and Haas Acrysol (Rhoplex) AC630 | 0 | 70 |
| Acrylic | | |
| Alberdingk AC2514 Self Cross-Linking Acrylic | 0 | 50 |
| Alberdingk AC2523 Self Cross-Linking Acrylic | 0 | 50 |
| Dow Corning DC65 defoamer | 0.5 | 2.5 |
| DuPont Zonyl FSJ Surfactant | 0.5 | 2 |
| Rohm and Haas Tamol 850 Dispersion Agent | 0.5 | 2.5 |
| Rohm and Haas Acrysol 2020NPR Thickener | 0 | 2 |
| Eastman Texanol Coalescent | 1 | 4 |
| Taminco Vantex T Zero VOC Amine Additive | 1 | 5 |
| Rohm and Haas Acrysol SCT275 Mid Shear | 0.2 | 0.5 |
| Thickener | | |
| Southern Clay Laponite RDS Suspension | 2 | 4 |
| Additive | | |
| Kathon LX 1.5%, Anti-Bacterial In-Can | 0 | 0.1 |
| Preservative | | |
| Rohm and Haas Acrysol ASE-60 Low Shear | 0.5 | 3 |
| Rheological Additive | | |
| Shell Chemicals MPG Industrial | 1 | 5 |
| Monopropylene Glycol | | |
| Angus Chemical AMP-95 pH Adjuster | 0 | 1 |
| Filtered Water | 2 | 10 |

In order to better illustrate the present invention, working examples embodying the flexible luminescent paints are described below.

### EXAMPLE 1

A flexible luminescent paint base resin was prepared by mixing parts by weight as given below.

Flexible luminescent paint base resin formulation and mixing procedure:

| | | Sample |
|---|---|---|
| CHEMICAL COMPONENTS OF | % By | quantity |
| LUMINESCENT PAINT BASE RESIN | Weight | (Kg) |
| Alberdingk M2959 Epoxy Acrylic Hybrid | 62.84% | 0.6284 |
| Rhoplex MC1834 Cementitious Acrylic | 21.30% | 0.2130 |
| DC65 defoamer | 1.60% | 0.0160 |
| Zonyl FSJ FluoroSurfactant | 1.10% | 0.0110 |
| Tamol 850 Pigment Dispersion Agent | 0.83% | 0.0083 |
| Acrysol 2020NPR High Shear Thickener | 0.27% | 0.0027 |
| Texanol Coalescent | 3.50% | 0.0350 |
| Acrysol SCT-275 Mid Shear Thickener | 0.26% | 0.0026 |
| Laponite RDS Suspension Additive, 5% solution | 3.00% | 0.0300 |
| in water | | |
| Clean Filtered Water | 2.70% | 0.0270 |
| Kathon LX 1.5%, Anti Bacterial In-Can | 0.20% | 0.0020 |
| Preservative | | |
| Acrysol ASE-60 Low Shear Rheological | 0.40% | 0.0040 |
| Additive | | |
| Monopropylene Glycol (MPG) | 2.00% | 0.0200 |
| AMP 95 pH Adjuster | 0.00% | 0.0000 |
| Total: | 100.00% | 1.0000 |

1. Weigh the required amount of Alberdingk M2959 Epoxy Acrylic resin and filter it into the mixing vat.

2. Position the mixer blade so that it is just above the base of the mixing vat.

3. Turn on the mixer motor and set the speed control so that the resin is being mixed at low speed. This speed should not create splashing of the resin, and create a smooth vortex.

4. Weigh the required amount of DC65 Defoamer and slowly pour into the vortex. Continue mixing at same speed for approximately 5 minutes.

5. Weigh the required amount of Zonyl FSJ or equivalent and slowly pour into the vortex. Continue mixing at same speed for approximately 5 minutes.

6. Weigh the required amount of Rhoplex MC 1834 resin and filter it into the mixing vat. Continue mixing at same speed for approximately 5 minutes.

7. Weigh the required amount of Tamol 850 dispersant or equivalent and pour slowly into the vortex. Continue mixing at same speed for approximately 5 minutes.

8. Weigh the required amount of Acrysol 2020NPR thickener and pour slowly into the vortex. The resin will begin to thicken as this is mixed, so slowly increase the speed to maintain a smooth vortex. Continue mixing at same speed for approximately 5 minutes.

9. Weigh the required amount of Texanol and very slowly trickle-pour this into the vortex. Continue mixing at same speed for approximately 5 minutes.

10. Dip a stainless spatula into the resin and then wipe it with a finger to check that there are no small beads. This beading can be caused by too rapid addition of the Texanol. The resin mix should be smooth to the touch.

11. Weigh the required amount of Acrysol SCT275 thickener and pour slowly into the vortex. The resin will begin to thicken as this is mixed, so slowly increase the speed to maintain a smooth vortex. Continue mixing at same speed for approximately 5 minutes.

12. Weigh the required amount of Laponite RDS 5% solution in water, and add slowly into the vortex. Continue mixing at same speed for approximately 5 minutes.

13. Prepare the required amount of filtered water. Do not add to the mixture yet.

14. Prepare the required amount of Kathon LX 1.5 and add a small amount of the filtered water, and mix with a spatula. Do not add to the mixture yet.

15. Weigh the required amount of Acrysol ASE-60 and add a small amount of the filtered water, and mix with a spatula. Do not add to the mixture yet.

16. Pour the remaining filtered water from Step 13 slowly into the vortex. Continue mixing at same speed for approximately 5 minutes.

17. Slowly add the Kathon/water solution from step 14 into the vortex. Continue mixing at same speed for approximately 5 minutes.

18. Slowly add the Acrysol ASE-60/water solution from step 15 into the vortex, increasing the speed of the mixer as the mixture begins to thicken. Continue mixing at same speed for approximately 10 minutes.

19. Weigh the required amount of monopropylene glycol (MPG) and add slowly into the vortex. Continue mixing at same speed for approximately 10 minutes.

20. Check the pH of the resin mix, it should be in the range of 8.3 to 8.4. If the pH is too low, then slowly add AMP95 pH adjuster whilst mixing, and recheck the pH level. Continue this method until the required pH is achieved. Continue mixing at same speed for approximately 5 minutes.

21. Dip the stainless spatula into the resin mix and again test for smoothness. There should be no beading. The resin mixture is now complete and ready for addition of the photoluminescent pigment. The resin may optionally be decanted into clean plastic sealed containers for storage until required for the addition of photoluminescent pigment.

Flexible luminescent paint formulation and mixing procedure:

| | | Sample |
|---|---|---|
| | % By | quantity |
| CHEMICAL COMPONENT | Weight | (Kg) |
| Luminescent Paint Base Resin Formula | 70.00 | 0.7000 |
| Photoluminescent Pigment | 30.00 | 0.3000 |
| Total: | 100.00% | 1.0000 |

Weigh the required amount of Base Resin into the mixing container. Set the speed of the mixer so that there is a smooth vortex.

Weigh the required amount of Luminescent Pigment and add very slowly into the mixing container. As the pigment is added, slowly increase the speed of the mixer so that a smooth vortex is maintained. Continue this process until all of the pigment has been added, and then continue mixing for approximately 10 minutes.

Decant the finished paint, through a stainless strainer, into labeled containers. Seal each container lid tightly. Product is now ready for use.

### EXAMPLE 2

A flexible luminescent paint base resin was prepared by mixing parts by weight as given below similar to the formulation and mixing procedure of Example 1. The flexible luminescent paint was then similarly prepared by mixing the base resin below with the photoluminescent pigment similar to the formulation and mixing procedure of Example 1.

| | | Sample |
|---|---|---|
| CHEMICAL COMPONENTS OF | % By | quantity |
| LUMINESCENT PAINT BASE RESIN | Weight | (Kg) |
| Alberdingk M2959 Epoxy Acrylic Hybrid | 47.13% | 0.4713 |
| Alberdingk M2954 Epoxy Acrylic Hybrid | 15.71% | 0.1571 |
| Rhoplex MC1834 Cementitious Acrylic Resin | 20.70% | 0.2070 |
| DC65 Defoamer | 1.90% | 0.0190 |
| Zonyl FSJ Surfactant | 1.10% | 0.0110 |
| Tamol 850 Dispersant | 0.83% | 0.0083 |
| Acrysol 2020NPR Thickener | 0.27% | 0.0027 |
| Texanol Coalescent | 3.50% | 0.0350 |
| Acrysol SCT275 Thickener | 0.26% | 0.0026 |
| Laponite RDS Suspender | 3.00% | 0.0300 |
| Water | 2.70% | 0.0270 |
| Kathon LX 1.5% Preservative | 0.20% | 0.0020 |
| Acrysol ASE-60 Rheological Additive | 0.70% | 0.0070 |
| Monopropylene Glycol (MPG) | 2.00% | 0.0200 |
| pH adjuster (adjust to pH 8.4) | 0.00% | 0.0000 |
| Total: | 100.00% | 1.0000 |

### EXAMPLE 3

A flexible luminescent paint base resin was prepared by mixing parts by weight as given below similar to the formulation and mixing procedure of Example 1. The flexible luminescent paint was then similarly prepared by mixing the base resin below with the photoluminescent pigment similar to the formulation and mixing procedure of Example 1.

| | | Sample |
|---|---|---|
| CHEMICAL COMPONENTS OF | % By | quantity |
| LUMINESCENT PAINT BASE RESIN | Weight | (Kg) |
| Alberdingk M2959 Epoxy Acrylic Hybrid | 47.13% | 0.4713 |
| Alberdingk M3000 Epoxy Acrylic Hybrid | 15.71% | 0.1571 |
| Rhoplex MC1834 Cementitious Acrylic Resin | 20.70% | 0.2070 |
| DC65 Defoamer | 1.90% | 0.0190 |
| Zonyl FSJ Surfactant | 1.10% | 0.0110 |
| Tamol 850 Dispersant | 0.83% | 0.0083 |
| Acrysol 2020NPR Thickener | 0.27% | 0.0027 |
| Texanol Coalescent | 3.50% | 0.0350 |
| Acrysol SCT275 Thickener | 0.26% | 0.0026 |
| Laponite RDS Suspender | 3.00% | 0.0300 |
| Water | 2.70% | 0.0270 |
| Kathon LX 1.5% Preservative | 0.20% | 0.0020 |
| Acrysol ASE-60 Rheological Additive | 0.70% | 0.0070 |
| Monopropylene Glycol (MPG) | 2.00% | 0.0200 |
| pH adjuster (adjust to pH 8.4) | 0.00% | 0.0000 |
| Total: | 100.00% | 1.0000 |

### EXAMPLE 4

A flexible luminescent paint base resin was prepared by mixing parts by weight as given below similar to the formulation and mixing procedure of Example 1. The flexible luminescent paint was then similarly prepared by mixing the base resin below with the photoluminescent pigment similar to the formulation and mixing procedure of Example 1.

| | | Sample |
|---|---|---|
| CHEMICAL COMPONENTS OF | % By | quantity |
| LUMINESCENT PAINT BASE RESIN | Weight | (Kg) |
| Alberdingk M2959 Epoxy Acrylic Hybrid | 34.56% | 0.3456 |
| Alberdingk M2954 Epoxy Acrylic Hybrid | 28.28% | 0.2828 |
| Rhoplex MC1834 Cementitious Acrylic Resin | 18.06% | 0.1806 |
| DC65 Defoamer | 2.40% | 0.0240 |
| Zonyl FSJ Surfactant | 1.10% | 0.0110 |
| Tamol 850 Dispersant | 0.83% | 0.0083 |
| Acrysol 2020NPR Thickener | 0.27% | 0.0027 |
| Texanol Coalescent | 3.50% | 0.0350 |
| Acrysol SCT275 Thickener | 0.40% | 0.0040 |
| Laponite RDS Suspender | 3.00% | 0.0300 |
| Water | 2.70% | 0.0270 |
| Kathon LX 1.5% Preservative | 0.20% | 0.0020 |
| Acrysol ASE-60 Rheological Additive | 2.30% | 0.0230 |
| Monopropylene Glycol (MPG) | 2.00% | 0.0200 |
| pH adjuster (adjust to pH 8.4) | 0.40% | 0.0040 |
| Total: | 100.00% | 1.0000 |

### EXAMPLE 5

A flexible luminescent paint base resin was prepared by mixing parts by weight as given below similar to the formulation and mixing procedure of Example 1. The flexible luminescent paint was then similarly prepared by mixing the base resin below with the photoluminescent pigment similar to the formulation and mixing procedure of Example 1.

| | | Sample |
|---|---|---|
| CHEMICAL COMPONENTS OF | % By | quantity |
| LUMINESCENT PAINT BASE RESIN | Weight | (Kg) |
| Alberdingk M2959 Epoxy Acrylic Hybrid | 22.60% | 0.2260 |
| Alberdingk M2954 Epoxy Acrylic Hybrid | 7.60% | 0.0760 |
| Rhoplex MC1834 Cementitious Acrylic Resin | 10.00% | 0.1000 |
| Spec Polymer RayCryl 708E Acrylic | 30.00% | 0.3000 |
| Spec Polymer RayFlex 610 Acrylic | 10.00% | 0.1000 |
| DC65 Defoamer | 1.90% | 0.0190 |
| Zonyl FSJ Surfactant | 1.10% | 0.0110 |
| Tamol 850 Dispersant | 0.83% | 0.0083 |
| Acrysol 2020NPR Thickener | 0.27% | 0.0027 |
| Texanol Coalescent | 1.60% | 0.0160 |
| Acrysol SCT275 Thickener | 0.20% | 0.0020 |
| Laponite RDS Suspender | 3.00% | 0.0300 |
| Water | 8.10% | 0.0810 |
| Kathon LX 1.5% Preservative | 0.20% | 0.0020 |
| Acrysol ASE-60 Rheological Additive | 0.60% | 0.0060 |
| Monopropylene Glycol (MPG) | 2.00% | 0.0200 |
| pH adjuster (adjust to pH 8.4) | 0.00% | 0.0000 |
| Total: | 100.00% | 1.0000 |

### EXAMPLE 6

A flexible luminescent paint base resin was prepared by mixing parts by weight as given below similar to the formulation and mixing procedure of Example 1. The flexible luminescent paint was then similarly prepared by mixing the base resin below with the photoluminescent pigment similar to the formulation and mixing procedure of Example 1.

| | | Sample |
|---|---|---|
| CHEMICAL COMPONENTS OF | % By | quantity |
| LUMINESCENT PAINT BASE RESIN | Weight | (Kg) |
| Alberdingk M2959 | 22.60% | 0.2260 |
| Alberdingk M2954 | 7.60% | 0.0760 |
| Rhoplex MC1834 Cementitious Acrylic Resin | 10.00% | 0.1000 |
| Spec Polymer RayCryl 708E Acrylic | 35.00% | 0.3500 |
| Spec Polymer RayFlex 610 Acrylic | 5.00% | 0.0500 |
| DC65 Defoamer | 1.90% | 0.0190 |
| Zonyl FSJ Surfactant | 1.10% | 0.0110 |
| Tamol 850 Dispersant | 0.83% | 0.0083 |
| Acrysol 2020NPR Thickener | 0.27% | 0.0027 |
| Texanol Coalescent | 1.60% | 0.0160 |
| Acrysol SCT275 Thickener | 0.20% | 0.0020 |
| Laponite RDS Suspender | 3.00% | 0.0300 |
| Water | 8.10% | 0.0810 |
| Kathon LX 1.5% Preservative | 0.20% | 0.0020 |
| Acrysol ASE-60 Rheological Additive | 0.60% | 0.0060 |
| Monopropylene Glycol (MPG) | 2.00% | 0.0200 |
| pH adjuster (adjust to pH 8.4) | 0.00% | 0.0000 |
| Total: | 100.00% | 1.0000 |

### EXAMPLE 7

A flexible luminescent paint base resin was prepared by mixing parts by weight as given below similar to the formulation and mixing procedure of Example 1. The flexible luminescent paint was then similarly prepared by mixing the base resin below with the photoluminescent pigment similar to the formulation and mixing procedure of Example 1.

| | | Sample |
|---|---|---|
| CHEMICAL COMPONENTS OF | % By | quantity |
| LUMINESCENT PAINT BASE RESIN | Weight | (Kg) |
| Alberdingk M2959 Epoxy Acrylic Hybrid | 22.60% | 0.2260 |
| Alberdingk M2954 Epoxy Acrylic Hybrid | 7.60% | 0.0760 |
| Rhoplex MC1834 Cementitious Acrylic Resin | 10.00% | 0.1000 |
| Spec Polymer RayCryl 708E Acrylic | 25.00% | 0.2500 |
| Spec Polymer RayFlex 610 Acrylic | 15.00% | 0.1500 |
| DC65 Defoamer | 1.90% | 0.0190 |
| Zonyl FSJ Surfactant | 1.10% | 0.0110 |
| Tamol 850 Dispersant | 0.83% | 0.0083 |
| Acrysol 2020NPR Thickener | 0.27% | 0.0027 |
| Texanol Coalescent | 1.60% | 0.0160 |
| Acrysol SCT275 Thickener | 0.20% | 0.0020 |
| Laponite RDS Suspender | 3.00% | 0.0300 |
| Water | 8.10% | 0.0810 |
| Kathon LX 1.5% Preservative | 0.20% | 0.0020 |
| Acrysol ASE-60 Rheological Additive | 0.60% | 0.0060 |
| Monopropylene Glycol (MPG) | 2.00% | 0.0200 |
| pH adjuster (adjust to pH 8.4) | 0.00% | 0.0000 |
| Total: | 100.00% | 1.0000 |

Extensive testing was conducted with thin metal panels coated with the paint and vinyl screen sheet printed with paint, with the paint in all cases in excess of 1 mm thick. The metal panels and vinyl screens withstood constant bending through 90 degrees in both directions without any cracking to the coating, with adhesion being maintained to the surface. The flexible luminescent paints may be applied, for example, to wood, metal, concrete and vinyl. Further examples of the invention described above have been made and tested and found to deliver the advantages described. The luminescent paint thus offers new and novel properties as compared to those paint and resin formulations known to the art.

The need for a useful flexible photoluminescent paints is made apparent by the list of applications and products. A partial list of such applications would include, for example, signs (warning, exit, advertising, building, directional, accident prevention and street signs), underground or building emergency illumination (including buildings and corridors, airplanes, mineshafts, subways and underground stations, air-raid shelters and hangars), street crosswalk, curb and lane markers, stairwells and stair tread illumination (especially fire stairs and edges of steps), vehicle markings (including cars, trucks, aircraft, boats, bicycles, trailers, life rafts, hand gliders and helium and hot air balloons), hard hats and safety helmets, safety clothing, skis and skateboards, ramps for water-skiing, marine buoys, camping, fishing and hunting equipment, house numbers, safety barricades, agricultural fencing and gate markers, bush and ski trail markers, telephone and electrical line markers, emergency vehicle ID markings, military and defense force applications, floor tiles, ceiling and wall panels, stair treads, seat inserts and table tops, fascia and outlines for locks and light switches, smoke detectors including directional markings, insect traps, alternatives to reflective markers and tapes, banners, novelties, etc. Emergency lighting must operate at all times and in adverse conditions and atmospheres (loss of power, fire, smoke, etc.) and hence creates special difficulties particularly suited to cold light renewable luminescent paints.

It should be understood the foregoing detailed description is for purposes of illustration rather than limitation of the scope of protection accorded this invention, and therefore the description should be considered illustrative, not exhaustive. While the invention has been described in connection with preferred embodiments, it will be understood that there is no intention to limit the invention to those embodiments. On the contrary, it will be appreciated that those skilled in the art, upon attaining an understanding of the invention, may readily conceive of alterations to, modifications of, and equivalents to the preferred embodiments without departing from the principles of the invention, and it is intended to cover all these alternatives, modifications and equivalents. The scope of the patent protection is to be measured as broadly as the invention permits. Accordingly, the scope of the present invention should be assessed as that of the appended claims and any equivalents falling within the true spirit and scope of the invention.

I claim:

1. A flexible luminescent paint comprising a hybrid epoxy acrylic waterborne emulsion resin, a cementitious acrylic emulsion resin, a glycol, a rheological additive, a surfactant, a defoamer, a coalescent, a suspension additive, water and a photoluminescent pigment.

2. The flexible luminescent paint of claim 1 wherein the glycol is monopropylene glycol.

3. The flexible luminescent paint of claim 2 wherein the monopropylene glycol is utilized to slow the cure rate of the emulsion.

4. The flexible luminescent paint of claim 1 wherein the photoluminescent pigment is an alkaline earth metal aluminate phosphor.

5. The flexible luminescent paint of claim 1 wherein the flexible luminescent paint additionally comprises a microbicide.

6. The flexible luminescent paint of claim 1 wherein the flexible luminescent paint comprises 50-70% hybrid epoxy acrylic waterborne emulsion resin and 15-30% cementitious acrylic emulsion resin.

7. The flexible luminescent paint of claim 1 wherein the flexible luminescent paint additionally comprises a pure acrylic emulsion resin.

8. The flexible luminescent paint of claim 7 wherein the flexible luminescent paint additionally comprises 5-50% pure acrylic emulsion resin.

9. The flexible luminescent paint of claim 7 wherein the flexible luminescent paint comprises 20-40% hybrid epoxy acrylic waterborne emulsion resin, 10-35% cementitious acrylic emulsion resin and 25-45% pure acrylic emulsion resin.

10. The flexible luminescent paint of claim 1 wherein the flexible luminescent paint additionally comprises a fluorescent pigment.

11. The flexible luminescent paint of claim 10 wherein the fluorescent pigment gives the flexible luminescent paint a daylight color.

12. The flexible luminescent paint of claim 10 wherein the fluorescent pigment up-converts the photoluminescent pigment emission spectra to the fluorescent pigment emission spectra.

13. The flexible luminescent paint of claim 12 wherein the photoluminescent pigment has a green glow color, the fluorescent pigment has a yellow daylight color and the flexible luminescent paint has a yellow glow color.

14. The flexible luminescent paint of claim 10 wherein the ratio of photoluminescent pigment to fluorescent pigment is within the range of 60:1 to 150:1.

15. The flexible luminescent paint of claim 1 wherein the flexible luminescent paint is applied to an article to produce a photoluminescent article.

16. A method for producing a flexible luminescent paint comprising mixing a hybrid epoxy acrylic waterborne emulsion resin, a cementitious acrylic emulsion resin, monopropylene glycol, a rheological additive, a surfactant, a defoamer, a coalescent, a synthetic layered silicate, a microbicide, water and a photoluminescent pigment.

17. The method for producing a flexible luminescent paint of claim 16 wherein the flexible luminescent paint additionally comprises a pure acrylic emulsion resin.

18. The method for producing a flexible luminescent paint of claim 16 wherein the flexible luminescent paint additionally comprises a fluorescent pigment.

19. The method for producing a flexible luminescent paint of claim 18 wherein the fluorescent pigment up-converts the photoluminescent pigment emission to the fluorescent pigment emission spectra.

20. The method for producing a flexible luminescent paint of claim 19 wherein the photoluminescent pigment has a green glow color, the fluorescent pigment has a yellow daylight color and the flexible luminescent paint has a yellow glow color.
